(19) United States
(12) Patent Application Publication
(10) Pub. No.: US 2007/0014359 A1
(43) Pub. Date: Jan. 18, 2007

(54) Direct mode derivation process for error concealment

(76) Inventors: Cristina Gomila, Princeton, NJ (US); Jill MacDonald Boyce, Manalapan, NJ (US)

Correspondence Address: THOMSON LICENSING INC., PATENT OPERATIONS, PO BOX 5312, PRINCETON, NJ, 08543-5312, US

(21) Appl. No.: 10/573,928

(22) PCT Filed: Oct. 9, 2003
(86) PCT No.: PCT/US03/31825

§ 371 Date: Mar. 30, 2006

(51) Int. Cl. H04N 11/02; H04N 11/04; H04B 1/66

(52) U.S. Cl. 375/240.16; 375/240.24; 375/240.27

(57) ABSTRACT

Temporal concealment of missing/lost macro blocks relies on the direction mode derivation process typically standardized in video decoders. Upon detecting an error in the form of a picture (FIG. 1) a co-located macro block is found previously transmitted picture. The motion vector for that co-local macro block is determined (FIG. 2). The identified macro block is predicted by motion compensating data from a second previously transmitted picture in accordance with the motion vector determined for the co-located macro block (FIG. 3).

### TECHNICAL FIELD

This invention relates to a technique for temporal concealment of missing/corrupted macroblocks in a coded video stream.

### BACKGROUND ART

In many instances, video streams undergo compression (coding) to facilitate storage and transmission. Presently, there exist a variety of compression schemes, including block-based schemes such as the proposed ISO MPEG AVC/ITU H.264 coding standard, often referred to as simply ITU H.264 or JVT. Not infrequently, such coded video streams incur data losses or become corrupted during transmission because of channel errors and/or network congestion. Upon decoding, the loss/corruption of data manifests itself as missing/corrupted pixel values that give rise to image artifacts.

Spatial concealment seeks to derive the missing/corrupted pixel values by using pixel values from other areas in the same image, thus exploiting the spatial redundancy between neighboring blocks in the same frame. In contrast to spatial error concealment, temporal concealment attempts the recovery of the coded motion information, namely the reference picture indices and the motion vectors, to estimate the missing pixel values from at least one previously transmitted macroblock, thus exploiting the temporal redundancy between blocks in different frames of the same sequence.

When undertaking temporal error concealment, each missing/corrupted macroblock is commonly estimated by motion compensating one or more previously transmitted macroblocks. Present day temporal concealment strategies typically accept sub-optimal solutions that minimize computational effort to reduce complexity and increase speed. Such sub-optimal solutions typically fall into two categories depending on whether they make use of spatial neighbors (within the same frame) or temporal neighbors (within other frames) to infer the value of the missing motion vector. Error concealment that makes use of spatial neighbors attempts the recovery of the motion vector of a missing block based on the motion information within the neighborhood. Such techniques assume a high correlation between the displacement of spatially neighboring blocks. When considering several motion vectors, the best candidate is found by computing the least MSE (Mean Square Error) between the external border information of the missing/corrupted block in the current frame and the internal border information of the concealed block from the reference frame. Such a procedure tends to maximize the smoothness of the concealed image at the expenses of an increased amount of computational effort. Faster algorithms compute the median or the average of the adjacent motion vectors, and propose this value as the motion vector of the missing block.

The other sub-optimal solution for error concealment makes use of temporal neighboring macro blocks. This approach attempts the recovery of the motion vector of a missing block by exploiting the temporal correlation between co-located blocks in neighboring frames. Typically, techniques that make use of temporal neighboring macroblocks assume that the lost block hasn't changed its location between two consecutive frames, which is equivalent to saying that the block's displacement can be modeled with a zero motion vector. On that basis, the temporal concealment of a missing block on the current frame occurs by simply copying the co-located block of the previously transmitted frame. Such a procedure affords speed and simplicity but achieves low performance on moving regions. Similar strategies exist in recently proposed video-coding standards to derive the motion vectors of a block for which no motion information has been transmitted, but offer limited performance.

Thus, there is a need for a technique for temporal concealment of lost/corrupted macroblocks that overcomes the aforementioned difficulties.

### BRIEF SUMMARY OF THE INVENTION

Briefly, in accordance with a first preferred embodiment, there is provided a technique for temporal concealment of a missing/corrupted macroblock in an array of macroblocks coded in direct-mode. The direct mode constitutes a particular inter-coding mode in which no motion parameters are transmitted in the video stream for a macroblock in a B slice or picture, in contrast to P frame-skipped macroblocks in which no data is transmitted. Initially, at least one macroblock in the array having missing/corrupted values is identified. Next, a co-located macroblock is located in a first previously transmitted picture comprised of an array of macroblocks and the motion vector for that co-located macroblock is determined. The motion vector (referred to as a “co-located motion vector”) is scaled in accordance with a Picture Order Count (POC) distance that generally corresponds to the distance between the identified macroblock and the co-located macroblock. The identified macroblock is predicted by motion compensating data from both the first picture and a second previously transmitted picture in accordance with the scaled co-located motion vector. This technique has applicability to video compressed in accordance a block-based compression technique that uses B frame pictures such as MPEG 4.

In accordance with a second preferred embodiment, there is provided a technique for temporal concealment of a missing/corrupted macroblock in an array of macroblocks coded in direct mode in accordance with a coding standard such as the ITU H.264 coding standard. Initially, at least one macroblock in the array having missing/corrupted values is identified. Next, a co-located macroblock is located in a first previously transmitted picture comprised of an array of macroblocks and the co-located motion vector and reference index for that co-located macroblock are determined. The co-located motion vector is scaled in accordance with the POC distance. A second previously transmitted picture is selected in accordance with the reference index and data from the both the first and second previously transmitted pictures are motion compensated using the scaled co-located motion vector to yield a prediction for the identified macroblock.

### BRIEF DESCRIPTION OF THE DRAWINGS

FIG. 1 depicts a partial array of macroblocks used for spatial-direct mode prediction;

FIG. 2 graphically depicts a technique for temporal-direct mode prediction for a B partition from first and second reference pictures;

FIG. 3 depicts the manner in which a co-location motion vector is scaled;

FIG. 4A depicts in flow chart form the steps of a method for achieving error concealment in accordance with the present principles using certain criteria applied a priori; and

FIG. 4A depicts in flow chart form the steps of a method for achieving error concealment in accordance with the present principles using certain criteria applied a posteriori.

### DETAILED DESCRIPTION

1. Background

The technique for temporal concealment of a missing/corrupted macroblock in accordance with the present principles can best be understood in the context of the ITU H.2.64 coding standard although, as described hereinafter, the technique has applicability to other coding standards, such the MPEG 4 coding standard. Thus, a brief discussion of the derivation process available for direct mode encoding in accordance with the ITU H.264 coding standard will prove helpful. The ITU H.264 coding standard permits the use of multiple reference pictures for inter-prediction, with a reference index coded to indicate which picture(s) are used among those in the reference picture buffer (not shown) associated with a decoder (not shown). The reference picture buffer holds two lists: list 0 and list 1. Prediction of blocks in P slices can occur using a single motion vector from different reference pictures in list 0 in accordance with a transmitted reference index denominated as “RefIdxL0” and a transmitted motion vector denominated as “MvL0”. Prediction of blocks in B slices can occur either from list 0 or from list 1 with a reference index and motion vector transmitted as either RefIdxL0 and MvL0, respectively from list 0 or a reference index “RefIdxL1” and motion vector “MvL1”, respectively, from list 1, but also using both lists in a bi-predictive mode. For this last case, prediction of the content of a block occurs by averaging the content of one block from list 0 and another block from list 1.

To avoid always transmitting RefIdxL0-MvL0 and/or RefIdxL1-MvL1, the H.264 standard also allows encoding of the blocks in B slices in direct mode. In this case, two different methods exist for deriving the non-transmitted motion vectors and reference picture indices. They include: (a) the spatial-direct mode, and (b) the temporal-direct mode. A description exists for each mode for progressive encoding assuming availability of all required information. Definitions for other cases exist in the specifications of the ITU H. 264 coding standard.

1.1. Spatial-Direct Motion Vector Prediction in the ITU H.264 Coding Standard

When invoking spatial-direct motion vector prediction for macroblock E of FIG. 1, reference indices for the list 0 and 1 are inferred from the neighboring blocks A-D in FIG. 1, in accordance with the following relationships
RefIdxL0=MinPositive(RefIdxL0A,MinPositive(RefIdxL0B,RefIdxL0C)) (Eq. 1)
RefIdxL1=MinPositive(ReIdxL1A,MinPositive(RefIdxL1B,RefIdxL1C)) (Eq. 2)
with the operator MinPositive given by

$$MinPositive ( a , b ) = \{ \begin{matrix}a & ; & ( b < 0 ) \vert \vert ( ( a \geq 0 ) \&\& ( a \leq b ) ) \\ b & ; & ( ( a < 0 ) \&\& ( b \geq 0 ) ) \vert \vert ( ( a \geq 0 ) \&\& ( b \geq 0 ) \&\& ( a > b ) )\end{matrix} \qquad ( Eq . 3 )$$

Each component of the motion vector prediction MvpLX (where X can be 0 or 1) is given by the median of the corresponding vector components of the motion vector MvLXA, MvLXB, and MvLXC:
MvpLX[0]=Median(MvLXA[0],MvLXB[0],MvLXC[0]) (Eq. 4)
MvpLX[1]=Median(MvLXA[1],MvLXB[1],MvLXC[1]) (Eq. 5)
Note that, when used for error concealment purposes, samples outside the slice containing E in FIG. 1 could be considered for prediction.

In the direct mode, determining the block size can become important, especially in connection with the ITU H.264 coding standard that allows for the use of different block sizes. When a spatial-direct mode indicated by an mb_type of Direct16×16 is used, a single motion vector and List 0 and List 1 reference indices are derived for the entire 16×16 macroblock. When the spatial-direct mode indicated by a sub_mb_type of Direct8×8 is used, or for the 8×8 sub-macroblock, a single motion vector and List 0 and List 1 reference indices are derived for the 8×8 sub-macroblock.

1.2. Temporal-Direct Motion Vector Prediction in the ITU H.264 Coding Standard

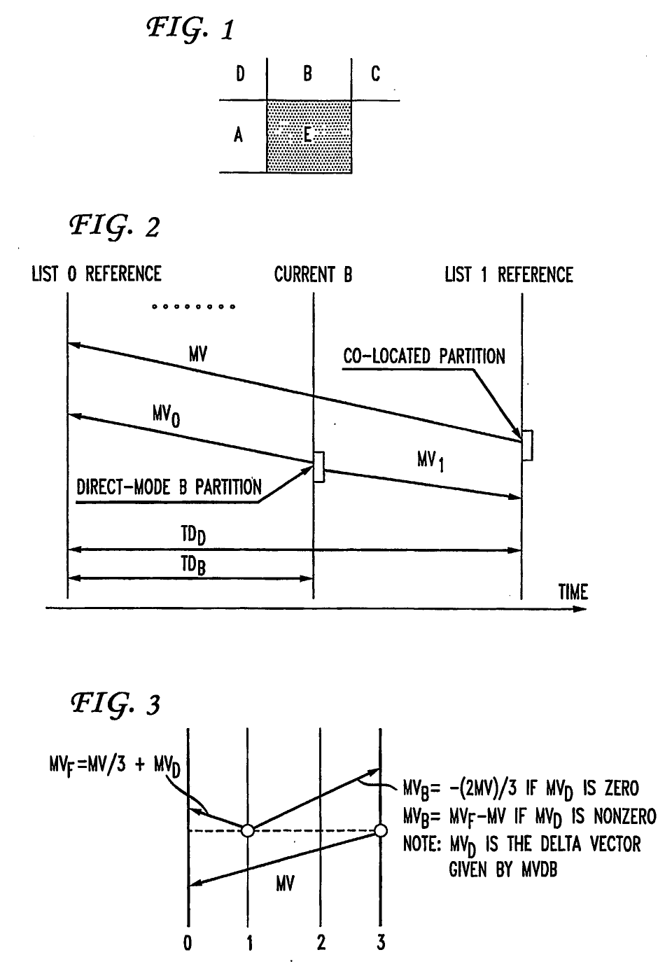

Taking as input data the address of the current macroblock (MbAddr), an exemplary algorithm for temporal-direct motion vector prediction computes the position of the co-located block on the first reference picture of the list 1 (see FIG. 2). The co-located block provides the parameters MvL0Col, MvL1Col, RefIdxL0Col and RefIdxL1Col, for estimating its content, and the MvVertScaleFactor as seen FIG. 2. From these values, the algorithm derives the value of the co-located motion vector MvCol, and the reference indices RefIdxL0 and RefIdxL1 as follows:

Set RefIdxL1=0, which is the first picture in list1.
If RefIdxL0Col is non-negative, the list 0 motion vector MvL0Col is assigned to MvCol and the list 0 reference index RefIdxL0Col is assigned to RefIdxL0:
   MvCol[0]=MvL0Col[0] (Eq. 6)
   MvCol[1]=MvVertScaleFactor×MvL0Col[1] (Eq. 7)
   RefIdxL0=RefIdxL0Col/MvVertScaleFactor (Eq. 8)
If RefIdxL1Col is non-negative, the list 1 motion vector MvL1Col is assigned to MvCol and the list 1 reference index RefIdxL1Col is assigned to RefIdxL0:
   MvCol[0]=MvL1Col[0] (Eq. 9)
   MvCol[1]=MvVertScaleFactor×MvL1Col[1] (Eq. 10)
   RefIdxL0={reference index in list L0 of referring to RefIdxL1Col in L1}/MvVertScaleFactor (Eq. 11)
Otherwise, the co-located 4×4 sub-macroblock partition is intra coded.
   The following relationships prescribe the motion vectors MvL0Col and MvL1Col:
   X=(16384+(TD_{D}>>1))/TD_{D} (Eq. 12)
   Z=clip3(−1024,1023,(TD_{B}·X+32)>>6) (Eq. 13)
   MvL0=(Z·MVCol+128)>>8 (Eq. 14)
   MvL1=MvL0−MVCol (Eq. 15)
   where clip3(a, b, c) is an operator that clips c in the range [a,b] and
   TD_{B}=clip3(−128,127, DiffPicOrderCnt(CurrentPic,RefIdxL0)) (Eq. 15)
   TD_{D}=clip3(−128,127,DiffPicOrderCnt(RefIdxL1,RefIdxL0)) (Eq. 16)
   In temporal direct mode, the derived motion vector is applied to the same size block of pixels as was used in the co-located macroblock. As may be appreciated from the foregoing relationships, the motion vector is scaled in accordance with a Picture Order Count distance, generally corresponding to the distance between the identified macroblock and a co-located macroblock.
   Direct Coding for MPEG 4

The MPEG 4 coding standard uses direct bidirectional motion compensation derived by extending the ITU H.263 coding standard that employs P-picture macroblock motion vectors and scaling them to derive forward and backward motion vectors for macroblocks in B-pictures. This is the only mode that makes it possible to use motion vectors on 8×8 blocks. This is only possible when the co-located macroblock in the predictive Video Object Plane (P-VOP) uses an 8×8 MV mode. In accordance with the ITU, H.263 coding standard, using B-frame syntax, only one delta motion vector is allowed per macroblock.

FIG. 3 shows scaling of motion vectors in connection with direct coding for the MPEG 4 coding standard. The first extension of the H.263 coding standard into the MPEG 4 coding standard provides that bidirectional predictions can be made for a full block/macroblock as in the MPEG-1 coding standard. The second extension of the ITU H.263 coding standard provides that instead of allowing interpolation of only one intervening VOP, more than one VOP can be interpolated. If the prediction is poor due to fast motion or large interframe distance, other motion compensation modes can be chosen.

Calculation of Motion Vectors

The calculation of forward and backward motion vectors involves linear scaling of the co-located block in the temporally next P-VOP followed by correction by a delta vector, and is thus practically identical to the procedure followed in the ITU H.263 coding standard. The only slight change is that with the MPEG 4 coding scheme, there are VOPs instead of pictures, and instead of only a single B-picture between a pair of reference pictures, multiple bidirectional VOPs (B-VOPs) are allowed between a pair of reference VOPs. As in H.263 coding standard, the temporal reference of the B-VOP relative to difference in the temporal reference of the pair of reference VOPs is used to determine scale factors for computing motion vectors, which are corrected by the delta vector. Furthermore, co-located Macroblocks (Mbs) are defined as Mbs with the same index when possible. Otherwise the direct mode is not used.

The forward and the backward motion vectors, referred to as “MV_{F}” and “MV_{B}”, respectively, are given in half sample units as follows.
MV_{F}=(TR_{B}×MV)/TR_{D}+MV_{D} (Eq. 17)
MV_{B}=((TR_{B}−TR_{D})×MV)/TR_{D} when MV_{D} is equal to 0 (Eq. 18), but
MV_{B}=MV_{F}−MV if MV_{D} is not equal to 0 (Eq. 19)
Where MV is the direct motion vector of a macroblock in P-VOP with respect to a reference VOP, TR_{B} is the difference in temporal reference of the B-VOP and the previous reference VOP. TR_{D} is the difference in temporal reference of the temporally next reference VOP with temporally previous reference VOP, assuming B-VOPs or skipped VOPs in between.
   2. Use of Spatial and Temporal Direct Derivation Processes for Error Concealment

In accordance with the present principles, the direct mode is used to derive: (1) the motion vectors (2) reference picture indices, (3) the coding mode (List 0/List 1/Bidir), and (4) the block size over which the coding mode is applied for concealment purposes. We have found that the process of deriving the information needed to predict corrupted/missing macroblocks defines a problem very close to recovery of direct-coded macroblocks by motion compensating data from previously transmitted frames. Accordingly, the same algorithm for predicting blocks encoded in direct mode can predict lost/corrupted blocks on inter-coded frames using any video decoder compliant with a standard for which the direct mode is defined as a particular case of inter-coding, with no extra implementation cost. This applies to current MPEG-4 and H.264 video decoders and could apply to MPEG-2 video decoders by implementing an algorithm for deriving the motion vectors in direct mode.

Error detection and error concealment constitute independent processes, the later invoked only when the former determines that some of the received data is corrupted or missing. When performing error detection at the macroblock level, if an error is detected on the currently decoded macroblock, concealment occurs without altering the decoding process. However, when error detection occurs at the slice level, all the macroblocks within the slice require concealment in front of an error. At this stage, many strategies exist for deciding the best order of concealment. In accordance with one simple strategy, error concealment starts on the first macroblock within the slice and progresses following the previous decoding order. More sophisticated strategies will likely evolve in other directions to avoid error propagation.

2.2. Criteria for Selecting a Derivation Process when More than One is Available

Error concealment in accordance with the present principles occurs by relying exclusively on the spatial-direct mode, on the temporal-direct mode or by making use of both modes. When making use of both modes, there must exist criterion for choosing which mode provides the better concealment on a particular block or macroblock. In the preferred embodiment, a distinction exists between criteria applied a priori, that is prior to actually selecting which of the two modes to use, and criteria applied a posteriori, that is, criteria applied after performing both modes to select which mode affords better results.

2.2.1. Criteria Applied a Priori:

The size of the region requiring concealment constitutes one criterion applied a priori to determine whether to use the spatial direct mode or the temporal direct. Temporal direct mode concealment affords better results on large regions, whereas the spatial direct mode affords better results on small regions. The concealment mode selected in other slices in the same picture constitutes another criterion for selecting a particular mode for concealment of a lost or missing slice. Thus, if other slices in the same picture are coded in the spatial direct mode, then that mode should be chosen for region of interest.

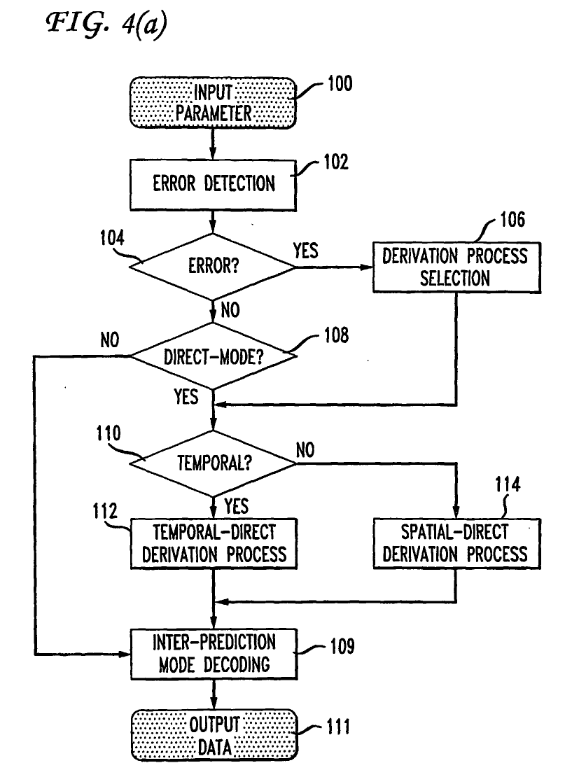

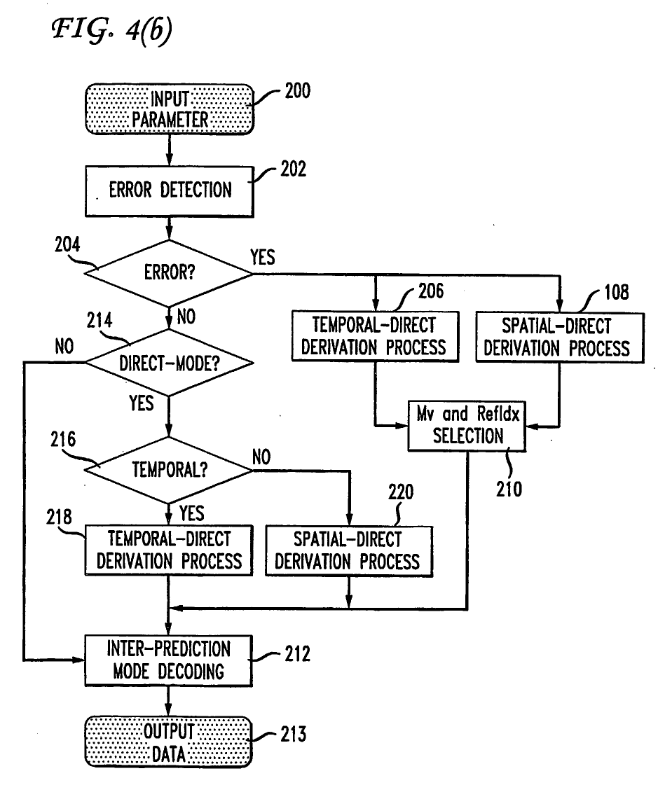

FIG. 4A depicts in flow chart form process for decoding and error concealment utilizing mode selection with an a priori criterion such as size or the concealment mode used for neighboring slices. A priori Mode selection commences upon the input of parameters that relate to the selected criterion (step 100). Thereafter, error detection occurs during step 102 to detect for the presence of missing/corrupted macroblocks. A check occurs during step 104 to determine whether an error exits in the form of a missing/lost macroblock. Upon finding an error during step 104, then a branch occurs to step 106 during which a selection is made of one of the temporal-direct or spatial-direct derivation modes in accordance with the input criterion.

Upon finding no error during step 104, then a check occurs during step 108 to determine whether the macroblock is coded in the direct mode. If not, then a branch occurs to step 109 whereupon the macroblock undergoes inter-prediction mode decoding prior to data output during step 111. If, during step 108 the macroblock is coded in direct mode, or following step 106, then a check occurs during step 110 whether selected mode was the temporal-direct mode. If so, then recovery of the motion vector and reference index occurs using the temporal-direct mode process during step 112 before proceeding to step 109. Otherwise, following step 110, recovery of the motion vector and reference index occurs by the spatial direct mode derivation process prior to executing step 109.

2.2.2. Criteria Applied a Posteriori:

As discussed previously, both the temporal direct mode and spatial direct mode derivation processes can both occur, with the results of a particular process selected in accordance with one of several criterion applied a posteriori. For example, both processes can occur while only retaining the results of the process that yields the smoothest transitions between the borders of the concealed block and its neighbors. Alternatively, both processes can occur while only retaining the process the yielded the lower boundary strength value at a deblocking filter, as measured following error concealment. A lower the boundary strength value affords a smoother transition and better motion compensation.

FIG. 4B depicts in flow chart form a process for decoding and error concealment utilizing mode selection that with an a posteriori criteria to determine mode selection. Mode selection in accordance with an a posteriori criterion commences upon the input of parameters that relate to the selected criterion (step 200). Thereafter, error detection occurs during step 202 to detect for the presence of missing/corrupted macroblocks. A check occurs during step 204 to determine whether an error exits in the form of a missing/lost macroblock exist. Upon finding an error during step 204, then a branch occurs to both steps 206 and 208. During step 206, the temporal-direct derivation processes commences to derive the motion vector and reference index in the manner described from neighboring reference blocks in the temporal domain. During step 208 the spatial-direct derivation processes commences to derive the motion vector and reference index in the manner described from neighboring reference blocks in the spatial domain. Thereafter, selection of the motion vector (Mv) and reference index (Refldx) occurs during step 210 in accordance with the criterion input during step 200. Following step 210, inter-prediction mode decoding commences during step 212 and the data resulting from that step is output during step 213.

Upon finding no error during step 204, then a check occurs during step 214 to determine whether the macroblock is coded in the direct mode. If not, then a branch occurs to step 213 described previously. Upon finding the macroblock coded in direct mode during step 214, then step 216 follows during which a check occurs during step to determine whether selected mode was the temporal-direct mode. If so, then recovery of the motion vector and reference index occurs using the temporal-direct mode process during step 218 before proceeding to step 212. Otherwise, following step 216, recovery of the motion vector and reference index occurs by the spatial direct mode derivation process during step 220 prior to executing step 212.

The foregoing describes a technique for temporal concealment of missing/corrupted macroblocks in a coded video stream.

1. A method for temporal concealment of at least one of a missing or corrupted macroblocks in a video stream coded in direct mode, comprising the steps of:
identifying at least one missing or corrupted macroblock;
finding a co-located macroblock in a first previously transmitted picture;
determining a co-located motion vector for the co-located macroblock;
scaling the co-located motion vector in accordance with a picture distance;
predicting the at least one missing or corrupted data for the identified macroblock by motion compensating data from both the first previously transmitted picture and a second previously transmitted reference picture in accordance with the scaled co-located motion vector.

2. The method according to claim 1 wherein the at least one missing or corrupted data is predicted using a temporal-direct mode.

3. The method according to claim 1 wherein the at least one missing or corrupted data is predicted using one of the temporal and spatial-direct modes derivation processes in accordance with at least one criterion selected prior to such predicting.

4. The method according to claim 3 wherein selection of one of the temporal and spatial-direct modes derivation processes is made in accordance with concealment region size.

5. The method according to claim 4 wherein selection of one of the temporal and spatial-direct modes derivation processes is made in accordance a derivation mode of neighboring slices.

6. The method according to claim 1 wherein the at least one missing or corrupted data is predicted by the steps of:
performing the temporal and spatial-direct modes derivation processes; and
selecting results of one of the temporal and spatial-direct modes derivation processes in accordance with at least one a posteriori criterion.

7. The method according to claim 1 further comprising the step of deriving a size of blocks in the first and second pictures to which to apply the co-located motion vector.

8. The method according to claim 1 wherein the results are selected in accordance with a boundary strength value of deblocking in accordance with the ITU H.264 coding standard.

9. The method according to claim 1 wherein the at least one missing or corrupted data is predicted using a temporal-direct mode defined in the ITU H.264 coding standard.

10. A method for temporal concealment of at least one missing or corrupted macroblocks in a video stream coded in direct mode in accordance with the ISOITU H.264 coding standard, comprising the steps of:
identifying at least one missing or corrupted macroblock;
finding a co-located macroblock in a first previously transmitted picture;
determining a reference index and a motion vector for the co-located macroblock;
scaling the motion vector;
selecting a second previously transmitted picture in accordance with the reference index; and
predicting the at least one missing or corrupted data for the identified macroblock by motion compensating data from the first and second previously transmitted reference pictures in accordance with the determined motion vector.

11. The method according to claim 10 wherein the at least one missing or corrupted data is predicted using a temporal-direct mode defined in the ITU H.264 coding standard.

12. The method according to claim 10 wherein the at least one missing or corrupted data is predicted using a spatial-direct mode defined in the ITU H.264 coding standard.

13. The method according to claim 10 wherein the at least one missing or corrupted data is predicted using one of the temporal and spatial-direct modes derivation processes defined in the ITU H.264 coding standard in accordance with at least one criterion selected prior to such predicting.

14. The method according to claim 10 wherein selection of one of the temporal and spatial-direct modes derivation processes in made in accordance with concealment region size.

15. The method according to claim 14 wherein selection of one of the temporal and spatial-direct modes derivation processes in made in accordance a derivation mode of neighboring slices.

16. The method according to claim 10 wherein the at least one missing or corrupted data is predicted by the steps of:
performing the temporal and spatial-direct modes derivation processes defined in the ITU H.264 coding standard; and
selecting results of one of the temporal and spatial-direct modes derivation processes in accordance with at least one a posteriori criterion.

17. The method according to claim 16 wherein the results are selected in accordance with a boundary strength value of deblocking in accordance with the ITU H.264 coding standard.
